(19) United States
(12) Patent Application Publication
(10) Pub. No.: US 2006/0220795 A1
(43) Pub. Date: Oct. 5, 2006

(54) Method and apparatus for tag with adjustable read distance

(75) Inventor: Praveen Limbachiya, Wellesley, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Supply Focus, Wellesley, MA (US)

(21) Appl. No.: 11/387,038

(22) Filed: Mar. 22, 2006

Related U.S. Application Data
(60) Provisional application No. 60/664,057, filed on Mar. 22, 2005.

(51) Int. Cl. H04Q 5/22

(52) U.S. Cl. 340/10.5; 340/572.7

(57) ABSTRACT

A RFID tag may be configured to selectively emit a signal including information, such as the identity of the tag and/or an associated item, that is detectable by a tag reader or other interrogator at different distances. The RFID tag may include hardware and/or software for changing the range of the RFID tag. For example, a tag may include more than one antenna. One antenna may be constructed and arranged to send a signal a greater distance than another antenna. The range may be changed by disabling an antenna and/or switching the antenna that is used to send a signal.

### BACKGROUND OF INVENTION

1. Field of Invention

The invention is directed to the use of radio frequency identification (RFID) tags with adjustable read distance.

2. Discussion of Related Art

An electronic tag typically is affixed to or otherwise associated with an item to be tracked or identified. Such tags may be implemented using a family of technologies that facilitate the transfer of data wirelessly between tagged items and electronic readers. For example, radio frequency identification (RFID) tags have a radio antenna that is capable of transmitting data. Such RFID tags, when used with a tag reader, allow tracking and/or identification of tagged items.

To uniquely identify tagged items, a naming system referred to as the electronic item code (EPC) has been developed. The EPC was created to accommodate current and future naming methods, and is intended to be universally and globally accepted as a means to link physical items to a computer network and to serve as an efficient information reference. A unique EPC assigned to an item may be stored in a RFID tag as a binary number of 64 or 96 bits long. (As used herein, a “number” can include numbers, letters or other suitable characters). In particular, the EPC bit string may include information regarding an item such as its manufacturer, the item type, and the item serial number, for example.

When queried (e.g., by a tag reader), the RFID tag may wirelessly transmit a representation of the EPC to the tag reader, which may decode and display information such as the manufacturer, item type, and/or serial number and/or send the received information to one or more other processing devices for decoding and subsequent routing. One such processing device that may receive communications from a tag reader (e.g., via a wireless local network or other communications system) commonly is referred to as an object naming service (ONS).

The object naming service (ONS) can link the EPC with one or more associated data files containing information relating to the tagged item. More specifically, the ONS is an automated networking service which, when given an EPC, returns a network address at which one or more data files corresponding to the tagged item may be located. The ONS is based on the concept of the standard domain naming service (DNS) used to identify website addresses based on a website name. In particular, the ONS parses the EPC to decode particular information in specific fields of the EPC so as to return the appropriate address where data is located.

A physical mark-up language (PML) is a standard in which network information about physical items may be written. PML essentially is an XML-based language for databasing information about physical items, and is designed to standardize descriptions of physical items for use by both humans and machines. In one aspect, PML serves as a common base for software applications, data storage and analytic tools for industry and commerce. As discussed above, once the ONS decodes an EPC, it returns an address to a PLM server which includes one or more databases in which are stored one or more files containing information regarding the tagged item. The PML server accesses this information and provides standardized data output regarding the tagged item using PML, which may be forwarded back to the tag reader. A user may review this information, e.g., to determine the manufacturer of a particular item.

Current RFID systems may be vulnerable to unauthorized persons reading the item identification numbers from RFID tags, gaining information related to the corresponding items, and using this information for unintended purposes. For example, if an item is tagged with a RFID tag having an identification number in standard EPC format, the identification number may be read, and knowledge about the item may be obtained by accessing information provided by an ONS or otherwise. Such knowledge may include the name of the manufacturer, the value of an item, or other item information, for example.

One method of preventing unauthorized persons from reading the item identification numbers from a RFID tag is to “kill” the RFID tag. “Killing” a RFID tag typically prevents the tag from communicating, thus making it impossible for unauthorized persons to read the item identification number from the tag. A RFID tag may be killed by sending a “kill-command” to the tag. Once the RFID tag receives the kill-command, it may take appropriate action to disable the tag. For example, the tag may execute software code to prevent the item identification number and/or other information from being accessed in the memory of the tag. In this example, a kill-command may include an appropriate sequence of numbers that the RFID tag is programmed to recognize. In another example, a RFID tag may be killed by applying an electromagnetic pulse to the tag that damages RFID tag electronics.

### SUMMARY OF INVENTION

The inventor has appreciated that current RFID systems are vulnerable to unauthorized persons reading the item identification numbers from RFID tags, gaining information related to the corresponding items, and using this information for unintended purposes. Because of this vulnerability, current RFID systems may raise concerns about privacy.

The inventor has also noted that “killing” a RFID tag may prevent the tag from being read, and may make it difficult or impossible for anyone to read information from the tag, including those who are authorized to do so. For example, a products tag may be “killed” after the product is purchased by a consumer. However, if the consumer later returns the product to the retailer, the retailer may not be able to read information from the tag, potentially preventing the retailer from easily confirming the products authenticity, the source of the product, etc.

The inventor has appreciated that it may be advantageous to provide for a RFID tag that has a greater range for a portion of its lifecycle and a lesser range for another portion of its lifecycle. For example, during a portion of its lifecycle it may be advantageous to reduce the range of a RFID tag to a relatively small distance, e.g., less than an inch, possibly less than the range of a bar code reader which may have a range of a few inches to over a foot.

In one aspect of the invention, a method of communicating with a RFID tag includes providing a RFID tag associated with an item, the RFID tag being constructed and arranged to send a response signal in response to receiving an interrogation signal from a RFID reader. The response signal may be readable by the RFID reader positioned no further than a maximum distance from the RFID tag. The RFID tag may be altered to reduce the maximum distance from the RFID tag at which the RFID reader can read the response signal sent from the RFID tag in response to receiving the interrogation signal.

In another aspect of the invention, a method of communicating with a RFID tag includes providing a RFID tag associated with an item, the RFID tag including at least two antennae adapted to be electrically connected to RFID tag electronics. The at least two antennae may be constructed and arranged to send a response signal in response to receiving an interrogation signal. The method further includes reducing the distance the RFID tag can send a response signal in response to the interrogation signal by causing the RFID tag to use only one of the at least two antennas, e.g., by disabling at least one of the antennae.

In yet another aspect of the invention, a method of communicating with a RFID tag includes providing a RFID tag associated with an item, the RFID tag being constructed and arranged to send a response signal in response to receiving an interrogation signal. The RFID tag may include at least two antennae and may be arranged to send, in response to receiving an interrogation signal, a response signal from using a first antenna. When using the first antenna, the response signal may be readable by a receiver at a first maximum distance from the RFID tag. The tag may also be arranged to send, in response to receiving an interrogation signal, a response signal from the RFID tag using a second antenna. When using the second antenna, the response signal may be readable by a receiver at a second maximum distance from the RFID tag.

In a further aspect of the invention, a RFID tag includes a first antenna constructed and arranged to send a response signal in response to receiving an interrogation signal. The RFID tag further includes a second antenna constructed and arranged to send a response signal a greater distance than the first antenna in response to receiving an interrogation signal.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a RFID tag that may read at two different distances from a RFID reader;

FIG. 2 is a schematic diagram of a RFID tag including two antennae and a fuse;

FIG. 3 is a schematic diagram of a RFID tag including two antennae and a switch; and

FIG. 4 is a schematic diagram of a RFID tag including an antenna that may be altered.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

As discussed above, the inventor has appreciated potential problems with current RFID systems for identification of items. For example, groups of items provided with RFID tags have item identification numbers stored in the tags, e.g., so that manufacturers, distributors, and retailers can tell them apart and/or obtain information about the items. However, current RFID systems may be vulnerable to unauthorized persons reading the item identification numbers from RFID tags, gaining information related to the corresponding items, and using this information for unintended purposes. Because of this vulnerability, current RFID systems may raise concerns about privacy.

In one scenario, a customer purchases an item with an associated RFID tag. Once the customer has purchased the item, the customer may no longer wish for anyone to be able to easily read information from the RFID tag. Using current RFID systems, someone may be able to read the information from the RFID tag by bringing a RFID reader into sufficient proximity with the tag. The customer may be concerned that easy access to the information stored on the RFID tag may jeopardize the customer's privacy. For example, someone may be able to use a RFID reader to determine information related to the item when the item is located inside the customer's home or car. Due to the relatively great read range of some RFID tags, it may be possible to obtain information related to the item without actually entering the customer's home or car.

One method of preventing access to information stored on the RFID tag may be to kill the tag as discussed above. For example, a retailer may kill the RFID tag once a customer has purchased the item to prevent anyone from reading the item identification number. However, killing the tag may not always be desirable. In some circumstances, it may be desirable to be able to access information stored on the RFID tag after the item has been sold. For example, if a customer returns the item to a retailer, the retailer may wish to obtain the item identification number, e.g., to verify that the item was purchased at the retailer and/or to re-stock the item. If the RFID tag has been killed, obtaining the item identification number may no longer be possible.

The inventor has appreciated that it may be advantageous in some circumstances to provide for a RFID tag that has a greater range during some of its life cycle and a lesser range at other times. It may be advantageous to reduce the maximum distance that the RFID tag can send a signal in response to receiving an interrogation signal from a RFID reader. Such a system may provide for a RFID tag which may be read throughout its lifecycle and yet may also provide for increased privacy with a reduced read distance during a portion of its lifecycle.

For example, during a portion of its lifecycle it may be advantageous to reduce the range of a RFID tag to a relatively small distance, e.g., less than an inch, possibly less than the range of a bar code reader which may have a range of a few inches to over a foot.

In one example, a plurality of items may be provided with associated RFID tags. The items with associated RFID tags may be provided in any suitable way. For example, the items may be shipped from a manufacturer to a distributor, transferred from one entity to another entity, and/or moved from one location to another location. Each item may have a corresponding RFID tag containing an item identification number, as discussed above. The item identification number may be used to track an item and/or obtain information related to the item. The item identification number and/or other information stored on a RFID tag may be accessed by sending an interrogation signal from a RFID reader or some other type of transmitter capable of sending signals that are readable by RFID tags. The RFID tags associated with the items may be constructed and arranged to send a response signal in response to receiving the interrogation signal from the RFID reader or other transmitter.

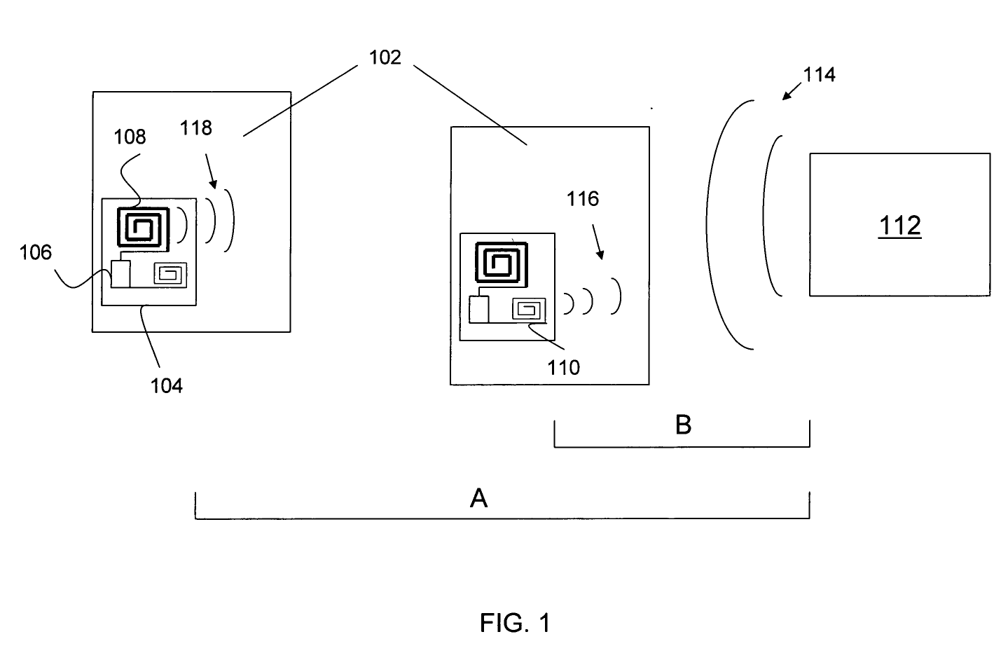

FIG. 1 shows a RFID tag 104 that may be read at a distance A and a distance B from a RFID reader 112. (As used herein, a read distance for a tag assumes a similarly configured tag reader or other device used to communicate with the tag. Of course, a tag may be capable of being read from different maximum distances by different readers, e.g., a more sensitive reader may be able to read a given tag from a further distance than another less sensitive reader. However, comparative read distances or distances over which a tag may send a readable signal as used herein refers to a same or similarly configured reader arranged at different distances from the tag.) During part of the life cycle of an item it may be desirable for a RFID tag that can be read at a relatively great distance from a RFID reader, e.g., distance A. For example, during transport of an item, e.g., from a manufacturer to a distributor, it may be desirable to read a RFID tag from a distance. By reading the tag at a greater distance, e.g., distance A in FIG. 1, time may be saved in reading the RFID tags associated with a plurality of items in a shipment. For example, if the items are shipped in a truck, the RFID tags may be read by bringing a RFID reader in proximity with the truck. Such a method may allow for reading the tags faster than if the RFID tags had a relatively small read distance. If the read distance of the RFID tags were relatively small, e.g., a few centimeters, it may be necessary to unload items from the truck to get the RFID reader close enough to read the tags.

The RFID tag 104 in FIG. 1 is associated with item 102, and may contain an item identification number. In response to receiving an interrogation signal 114, RFID tag 104 may retrieve the item identification number in RFID tag electronics 106 and send a response signal 118 using antenna 108. In some circumstances, antenna 108 may be constructed and arranged to send a response signal 1 18 with sufficient power that RFID reader 1 12 can read the response signal 1 18 at distance A from RFID tag 104. In this example, the response signal 1 18 sent by antenna 108 is readable by RFID reader 112 at distances up to and including distance A from the RFID reader. It may be desirable to configure the RFID tag to use antenna 108 during a portion of the lifecycle of the RFID tag, e.g., during shipping of the item as discussed in the above.

At some point in the lifecycle of the item, it may be advantageous to reduce the maximum distance that the RFID tag is capable of sending a response signal in response to an interrogation signal. Some methods of altering the RFID tag to reduce the maximum distance are discussed below. The range of the RFID tag may be reduced to any suitable distance, e.g., a few centimeters or less. By reducing the maximum distance that the RFID tag can send a response signal, it may be necessary for a RFID reader to come into very close proximity with the RFID tag to read the tag. Reducing the range of the RFID tag may prevent unauthorized persons from reading information stored on the RFID tag without very closely approaching the tag. For example, if the range of the RFID tag is reduced to a few centimeters, the RFID tags in the shipment may be read only by bringing a RFID reader into close proximity to the tag inside of a truck or container in which items are shipped. In another example, if a consumer purchases an item with an associated RFID tag having a reduced range, it may not be possible to determine information about the items without locating a RFID reader inside of the customer's house or car in which the item and RFID tag are located. However, once the range is reduced it may still be possible to read the information stored on the RFID tag if a reader is brought sufficiently close to the RFID tag.

Once the range of the RFID tag is reduced, the RFID tag may send a response signal 116 at distances up to and including distance B from the RFID reader. It is to be appreciated that FIG. 1 is not drawn to scale. Distance A may be any distance greater than distance B. As one example, distance A may be a few meters and the distance B may be a few centimeters, although neither distance A nor distance B are limited to any particular distance. The maximum range that an antenna can send a signal can be any suitable distance. The examples provided above in meters, centimeters, inches, and feet are provided merely by way of illustration.

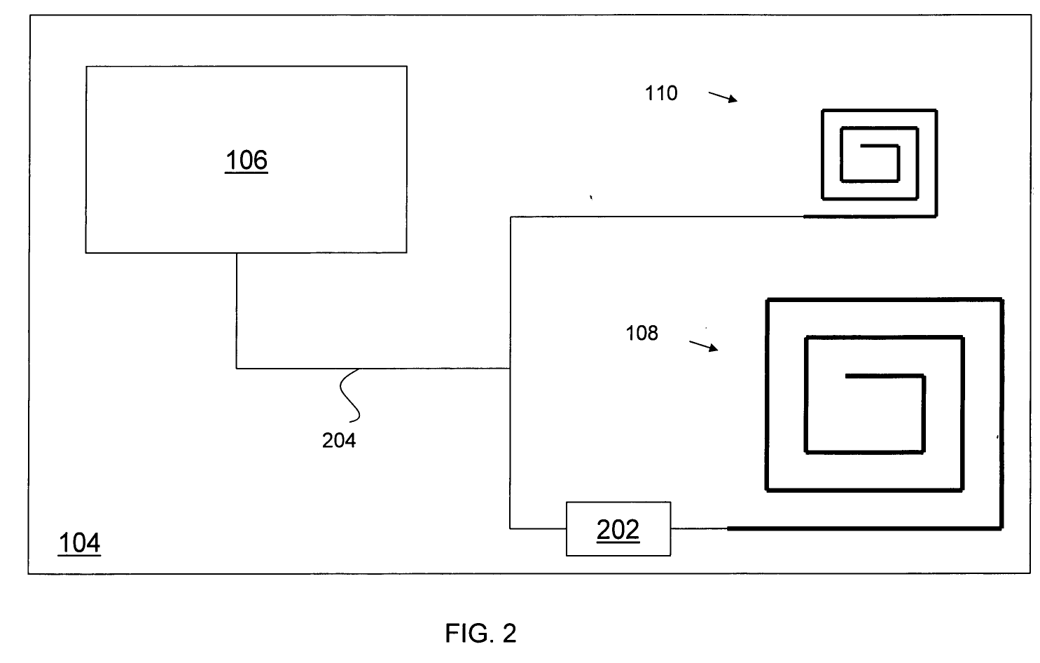

There are many ways in which one could alter the RFID tag to reduce the maximum distance at which a RFID reader can read the response signal sent from the RFID tag. One embodiment which may be used to reduce the range of the RFID tag is shown in FIG. 2. FIG. 2 shows a RFID tag 104 including RFID tag electronics 106 on which may be stored an item identification number, for example. RFID tag 104 also includes antenna 108 and antenna 110. As shown in FIG. 2, antenna 108 is larger than antenna 1 10 and may be capable of sending a response signal a greater distance than antenna 110. Antennae 108 and 1 10 are both electrically connected to RFID tag electronics 106 by electrical connection 204. In this example, antenna 108 is electrically connected to RFID tag electronics 106 through a fuse 202 in series with the electrical connection 204 and antenna 108.

In this embodiment, antenna 108 may be disabled by blowing fuse 102, thus disabling the electrical connection between antenna 108 to RFID tag electronics 106. It is to be noted that any suitable antenna size, shape, and/or configuration may be used. For example, antenna 110 does not necessarily need to be constructed in the same shape as antenna 108.

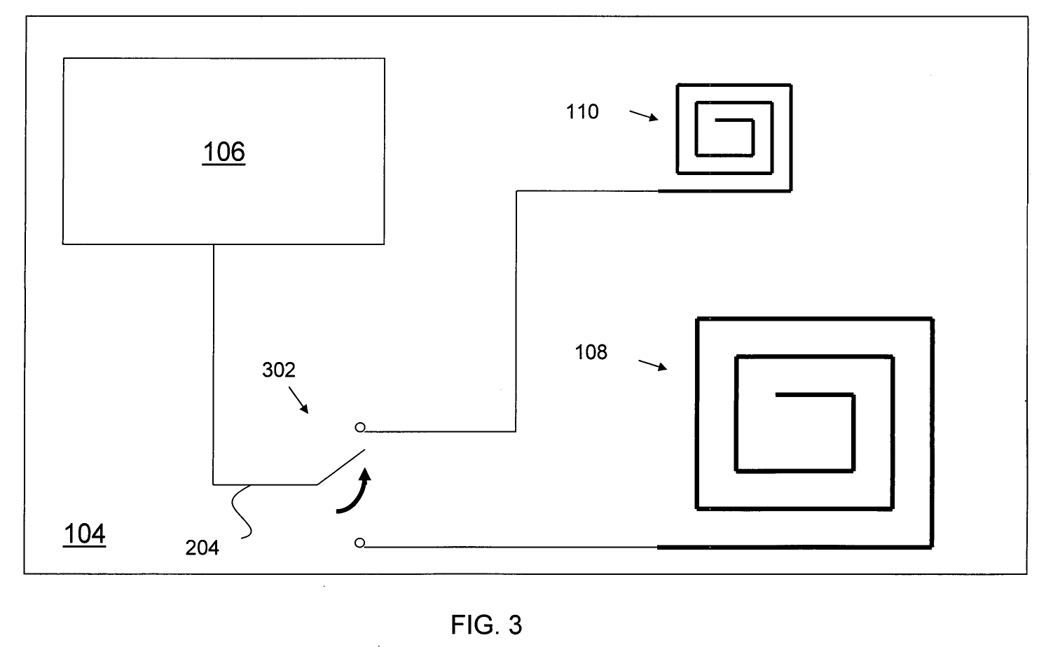

FIG. 3 shown another embodiment in which antenna 108 may be disabled. In FIG. 3, RFID tag 104 has similar components to those shown in FIG. 2. In FIG. 3 a switch 302 is used to disable antenna 108 by removing the electrical connection from antenna 108 to RFID tag electronics 106. In this embodiment, once antenna 108 is disabled, antenna 110 is enabled. The embodiment shown in FIG. 3 may be used to alter the RFID tag to reduce the maximum distance from the RFID tag at which the RFID reader can read the response signals sent from the RFID tag in response to receiving the interrogation signal.

As shown in FIG. 3, switch 302 is a hardware switch, e.g., a transistor. However, the read range of the RFID tag 104 may also be reduced by using a software switch instead of hardware switch 302. Any suitable software code may be used to implement a software switch. For example, the code may include a set of instructions directing a processor to drive antenna 110 instead of antenna 108 for sending a response signal. Any suitable software and/or hardware may be used to change the antenna which is used for sending the response signal or otherwise adjust the distance at which a response signal may be read.

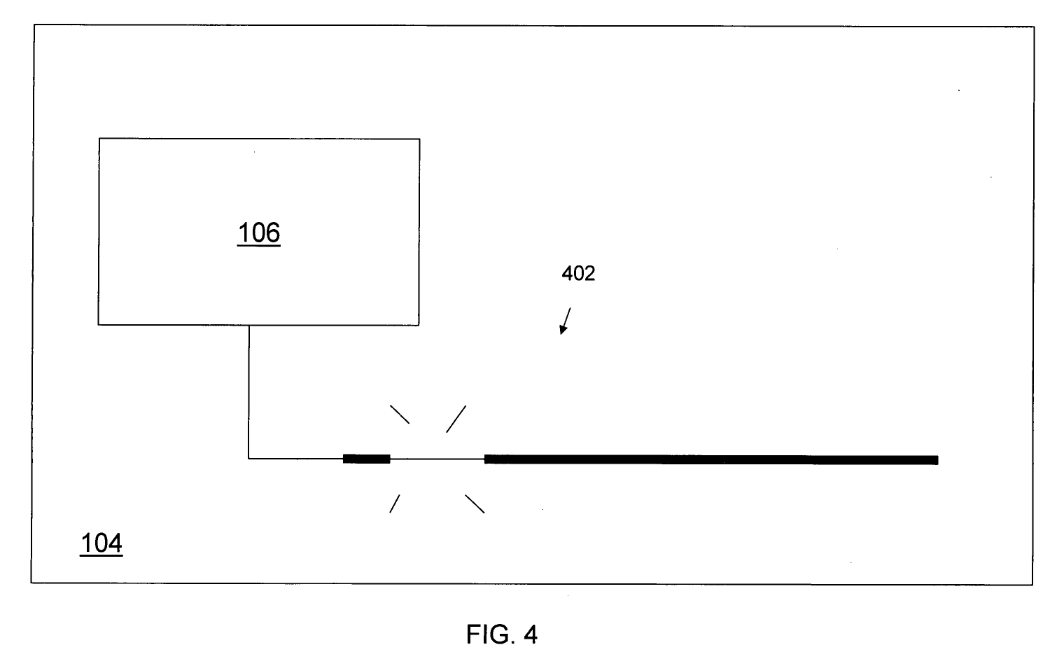

FIG. 4 shows another example of altering the RFID tag to reduce the range of the RFID tag. FIG. 4 shows a RFID tag 104 having antenna 402 connected to RFID tag electronics 106. Antenna 402 may be reduced in size by, for example, breaking an electrical connection to part of antenna 402 as shown in FIG. 4. Electrical connection may be broken in any suitable way. For example, antenna 402 may be constructed and arranged to have an electrical connection to part of antenna 402 be disabled, e.g., by applying a high current to antenna 402. The electrical connection may be broken because part of the antenna is constructed with very thin metal which reaches a very high temperature and vaporizes when high current is applied. For example, by reducing the size of antenna 402 in this manner, the RFID tag may be altered to reduce the distance that it can send a response signal in response to an interrogation signal. Alteration of the antenna 402 may be performed by a device external to the tag, such as a device at a retail checkout counter.

The range of an RFID tag may be reduced practicing the embodiments described above. The reduction of the range of the RFID tag may be triggered in any suitable way. In one example, a representation of a password may be transmitted to the RFID tag, e.g., by an RFID reader or other device encoded with the password to alter the RFID tag. Once the tag receives the representation of the password, the RFID tag may compare the password with a word stored in the memory of the tag to verify that the password is correct. Once the password has been verified, the RFID tag may be altered to reduce the range of the tag, e.g., using one or more of the embodiments described above. In another example, an electromagnetic pulse may be applied to the tag to reduce the range of the tag, e.g., to blow a fuse connecting a large antenna to tag electronics.

Other approaches for reducing the ability of a reader to read a response signal sent by a tag may be employed in accordance with the invention. For example, the tag electronics may be adjusted to reduce the power of signals emitted in ways other than changing the antenna size, shape or configuration. For example, the gain of an amplifier used by the tag electronics to generate a signal in response to being interrogated may be adjusted to change the range at which the tag's signal can be read.

In the examples and embodiments discussed above, any suitable device may be used to transmit an interrogation signal that is readable by an RFID tag. Such a suitable device may be a hand-held RFID reader, but need not necessarily be a hand-held RFID reader. Static RFID readers and/or any other suitable transmitting device may be used to interrogate a RFID tag. Any suitable transmitting device may be used to trigger a change in the range of a RFID tag, e.g., a tag reader or a device constructed to trigger the reduction in range of RFID tags. Such a device may be hand-held or static, and is not intended to be limited to any particular type or configuration.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of communicating with a RFID tag, the method comprising:
providing a RFID tag associated with an item, the RFID tag being constructed and arranged to send a response signal in response to receiving an interrogation signal from a RFID reader, the response signal being readable by the RFID reader when positioned no further than a maximum distance from the RFID tag; and
altering the RFID tag to reduce the maximum distance from the RFID tag at which the RFID reader can read the response signal sent from the RFID tag in response to receiving the interrogation signal.

2. The method of claim 1 wherein altering the RFID tag comprises removing an electrical connection to part of an antenna included with the RFID tag.

3. The method of claim 1 wherein altering the RFID tag comprises removing the electrical connection between an antenna included in the RFID tag and RFID tag electronics by blowing a fuse.

4. The method of claim 1 wherein altering the RFID tag comprises switching the antenna used to send the response signal from the RFID tag in response to receiving the interrogation signal.

5. The method of claim 4 wherein switching the antenna comprises switching a hardware switch.

6. The method of claim 4 wherein switching the antenna comprises executing software code.

7. A method of communicating with a RFID tag, the method comprising:
providing a RFID tag associated with an item, the RFID tag comprising at least two antennae adapted to be electrically connected to RFID tag electronics, the at least two antennae being constructed and arranged to send a response signal in response to receiving an interrogation signal; and
reducing the distance the RFID tag can send a response signal detectable by an interrogator in response to receiving the interrogation signal by disabling at least one of the antennae.

8. The method of claim 7 wherein one of the at least two antennae is capable of sending the response signal a greater distance than another of the at least two antennae.

9. The method of claim 7 wherein reducing the distance comprises removing the electrical connection from an antenna included in the RFID tag to RFID tag electronics by blowing a fuse.

10. The method of claim 7 wherein reducing the distance comprises switching the antenna used to send the response signal from the RFID tag in response to receiving the interrogation signal.

11. The method of claim 10 wherein switching the antenna comprises switching a hardware switch.

12. The method of claim 10 wherein switching the antenna comprises executing software code.

13. The method of claim 7 further comprising sending a trigger signal to the RFID tag to trigger reducing the distance the RFID tag can send a response signal by disabling at least one of the antennae.

14. The method of claim 13 wherein the trigger signal is sent by the RFID reader.

15. The method of claim 13 wherein the trigger signal comprises a representation of a password.

16. A method of communicating with a RFID tag, the method comprising:
providing a RFID tag associated with an item, the RFID tag being constructed and arranged to send a response signal in response to receiving an interrogation signal, the RFID tag comprising at least two antennae;
sending, in response to receiving an interrogation signal, a response signal from the RFID tag using a first antenna, the response signal being readable by a receiver at a first maximum distance from the RFID tag; and
sending, in response to receiving an interrogation signal, a response signal from the RFID tag using a second antenna, the response signal being readable by a receiver at a second maximum distance from the RFID tag.

17. The method of claim 16 further comprising reducing the distance the RFID tag can send a response signal in response to receiving the interrogation signal by disabling at least one of the antennae.

18. The method of claim 17 further comprising sending a trigger signal to the RFID tag to trigger reducing the distance the RFID tag can send a response signal by disabling at least one of the antennae.

19. The method of claim 17 wherein the first maximum distance is greater than the second maximum distance.

20. A RFID tag, comprising:
a first antenna constructed and arranged to send a response signal in response to receiving an interrogation signal; and
a second antenna constructed and arranged to send a response signal a greater distance than the first antenna in response to receiving an interrogation signal.

21. The RFID tag of claim 20 wherein the first antenna is smaller than the second antenna.

22. The RFID tag of claim 20 further comprising memory and a representation of a password stored in the memory.

23. The RFID tag of claim 20 further comprising a fuse electrically connected to the second antenna.

24. The RFID tag of claim 20 further comprising a switch electrically connected to the second antenna.

25. The RFID tag of claim 20 further comprising memory and computer executable instructions stored thereon which, when executed, reduce the maximum distance from the RFID tag at which a RFID reader can read a response signal sent from the RFID tag in response to receiving an interrogation signal.
